(19) United States
(12) Patent Application Publication
(10) Pub. No.: US 2021/0388006 A1
(43) Pub. Date: Dec. 16, 2021

(54) METHOD FOR PRODUCING DIALKYLAMIDO ELEMENT COMPOUNDS

(71) Applicant: UMICORE AG & CO, KG, Hanau-Wolfgang (DE)

(72) Inventors: Susanne HERRITSCH, Marburg (DE); Joerg SUNDERMEYER, Marburg (DE); Angelino DOPPIU, Seligenstadt (DE); Annika FREY, Hanau (DE); Ralf KARCH, Kleinostheim (DE); Andreas RIVAS NASS, Bensheim (DE); Wolf SCHORN, Waldbronn (DE); Eileen WOERNER, Nidderau (DE)

(73) Assignee: UMICORE AG & CO, KG, Hanau-Wolfgang (DE)

(21) Appl. No.: 17/273,787

(22) PCT Filed: Sep. 5, 2019
(86) PCT No.: PCT/EP2019/073633

§ 371 Date: Jul. 7, 2021

(30) Foreign Application Priority Data
Sep. 7, 2018 (EP) 18193179.1

(51) Int. Cl. C07F 5/06; C07F 9/06; C07F 7/00; C07F 9/00; C07F 9/68; C07F 9/90; C07F 9/94; C07F 7/02

(52) U.S. Cl. CPC C07F 5/061; C07F 9/06; C07F 7/003; C07F 7/025; C07F 9/68; C07F 9/902; C07F 9/94; C07F 9/005

(57) ABSTRACT

The invention relates to a method for producing dialkylamido element compounds. In particular, the invention relates to a method for producing dialkylamido element compounds of the type E(NRR′)ₓ, wherein first WAIN is reacted with HNRR′ in order to form M[Al(NRR′)₄] and hydrogen, and then the formed M[Al(NRR′)₄] is reacted with EXₓ in order to form E(NRR′)ₓ and M[AlX₄], wherein M=Li, Na, or K, R=CₙH₂ₙ₊₁, where n=1 to 20, and independently thereof R′=CₙH₂ₙ₊₁, where n=1 to 20, E is an element of the groups 3 to 15 of the periodic table of elements, X=F, Cl, Br, or I, and x=2, 3, 4 or 5.

The invention relates to a method for producing dialkylamido element compounds. In particular, the invention relates to a method for producing dialkylamido element compounds of the type E(NRR′)ₓ, wherein first M[AlH₄] is reacted with HNRR′ in order to form M[Al(NRR′)₄] and hydrogen, and then the formed M[Al(NRR′)₄] is reacted with EXₓ in order to form E(NRR′)ₓ and M[AlX₄], wherein M=Li, Na, or K, R=CₙH₂ₙ₊₁, where n=1 to 20, and independently thereof R′=CₙH₂ₙ₊₁, where n=1 to 20, E is an element of the groups 3 to 15 of the periodic table of elements, X=F, Cl, Br, or I, and x=2, 3, 4 or 5.

Volatile homoleptic metal and nonmetal amides of secondary amines having a high vapor pressure, such as Ti(NMe₂)₄, Zr(NMeEt)₄, Ta(NMe₂)₅, Ta(NMeEt)₄, Nb(NMe₂)₅, Bi(NMe₂)₃, As(NMe₂)₃, P(NMe₂)₃, B(NMe₂)₃, Si(NMe₂)₄, Ge(NMe₂)₄, serve as sources for the vapor deposition of elemental or metal nitrides and nitride carbides according to the MOCVD or MOVPE method or also according to the ALD method. The metal nitrides are used inter alia as electroceramic diffusion barriers for copper in the contacting of ever smaller nanostructured silicon wafer semiconductor components in integrated circuits. The non-metal nitrides BN or Si₃N₄ are in turn important “high k” materials, i.e. insulators of particular quality, or they are used in surface finishing by means of ceramic hard material coatings. B(NMe₂)₃, As(NMe₂)₃ and P(NMe₂)₃ can be used as reactive sources for Bi, As or P in the production and doping of III-V semiconductors.

Metal amides are often prepared by reacting lithium amides LiNRR′ generated in situ with metal chlorides in hydrocarbons. In rare cases, ethers are also mentioned as solvents. When ethers are used, however, there is the risk of ether cleavage due to the lithium alkyls reacting before they are reacted with amines to form lithium amides, as well as the risk of contamination of the amides with oxygen impurities. H. Nöth et al. report on Li[Al(NMe₂)₄] in Z. Naturforsch. 43b, 53-60 (1988).

Further disadvantages of the classical synthesis route are:

1. a high salt load (one equivalent LiCl respectively per halogen): Solid which forms in large quantities can lead to problems in the process during mixing; solid has to be filtered off; depending on the solvent used, the salt (LiCl) formed dissolves relatively well and is thus difficult to remove completely.
2. a high enthalpy on addition of LiNMe₂: Heat must be dissipated well, while at the same time low reaction temperatures are usually required in order not to decompose the target products.
3. LiNMe₂ is only slightly soluble (low molar concentrations) when used as a solution: high solvent quantities are therefore necessary and low space-time yields result.
4. Products are difficult to separate depending on the solvent used.
5. Impurities due to organic solvents.

It was, therefore, the object of the present invention to provide an alternative synthesis route for dialkylamido element compounds which overcomes the disadvantages of the prior art described above. In particular, the alternative synthesis route should be highly selective with respect to the target compounds.

It has now surprisingly been found that the compounds of the type M[Al(NRR′)₄], which can be isolated in a virtually quantitative yield or can be produced in situ, are able to exchange the aluminum-bonded amide groups for elemental halides of metals and non-metals. In addition to the target compounds of type E(NRR′)ₓ, tetrahaloaluminates M[AlX₄] are formed which, in contrast to LiCl, are particularly readily separable.

Also conceivable is the production of heteroleptic compounds E(NRR′)ₓX_{y} in which the halide ligands are replaced only partially by amide ligands by using only the stoichiometrically required amount of M[Al(NRR′)₄]. The heteroleptic compounds can then be further functionalized by known methods, for example introduction of alkyl groups, introduction of other amidine ligands, etc.

The present invention therefore relates to a method for producing compounds of type E(NRR′)ₓ comprising the following steps:

a) reacting M[AlH₄] with HNRR′ to form M[Al(NRR′)₄] and hydrogen;
b) reacting M[Al(NRR′)₄] with EXₓ to form E(NRR′), and M[AlX₄],
wherein M=Li, Na or K, R=CₙH₂ₙ₊₁, where n=1 to 20, and independently thereof R′=CₙH₂ₙ₊₁, where n=1 to 20, E is an element of the groups 3 to 15 of the periodic table of the elements, preferably Zr, Ta, Nb, Bi, As, P, B, Si or Ge, X=F, Cl, Br or I and x=2, 3, 4 or 5.

For the purposes of the present invention, R and R′ are selected independently of one another from the group consisting of CH₃ (n=1), C₂H₅ (n=2), C₃H₇ (n=3), C₄H₉ (n=4), C₅H₁₁ (n=5), C₆H₁₃ (n=6), C₇H₁₅ (n=7), C₈H₁₇ (n=8), C₉H₁₉ (n=9), C₁₀H₂₁ (n=10), C₁₁H₂₃ (n=11), C₁₂H₂₅ (n=12), C₁₃H₂₇ (n=13), C₁₄H₂₉ (n=14), C₁₅H₃₁ (n=15), C₁₆H₃₃ (n=16), C₁₇H₃₅ (n=17), C₁₈H₃₇ (n=18), C₁₉H₃₉ (n=19) and C₂₀H₄₁ (n=20).

In the context of the present invention, R and R′ independently of one another comprise both unbranched and branched hydrocarbon radicals.

In a preferred embodiment of the method according to the invention, R=R′=CH₃ or C₂H₅ or C₃H₇.

In an alternative preferred embodiment of the method according to the invention, R=CHs and R′=C₂H₅

In a further independently preferred embodiment of the method according to the invention, M=Li or M=Na.

In a further independently preferred embodiment of the method according to the invention, X=Cl.

In a further independently preferred embodiment of the method according to the invention, step b) is carried out in an organic solvent, preferably in squalane or dodecylbenzene.

In an alternative independently preferred embodiment of the method according to the invention, step b) is not carried out in a chemically inert solvent. A solvent is chemically inert when it does not react with potential reactants under the conditions given in each case.

Particular preference is given to the performance in an amine, e.g. dimethylamine, as solvent, wherein M[Al(NRR′)₄] is produced in situ in excess amine and further reacted directly or M[Al(NRR′)₄] is reacted in liquid amine with the desired elemental halide.

In a further independently preferred embodiment of the process according to the invention, step a) and step b) are carried out in a temperature range of from −80° C. to 0° C., particularly preferably in a temperature range from −60° C. to −20° C.

In an alternative independently preferred embodiment of the process according to the invention, step b) is carried out in a temperature range of from 0° C. to 150° C., more preferably in a temperature range of from 20° C. to 100° C.

In a further independently preferred embodiment of the process according to the invention, in step b), after the reaction has taken place, the end product E(NRR′)ₓ is obtained by extraction with a hydrocarbon, preferably pentane or hexane.

In a further independently preferred embodiment of the process according to the invention, excess amine HNRR′ is removed after step a) and before step b).

The process according to the invention allows dialkylamines to be activated in that the amines react with alkali tetrahydridoaluminates M[AlH₄] as low-cost bases to form alkali tetrakis(dialkylamino)aluminates M[Al(NRR′)₄] and react with hydrogen (step a).

In general, it is advisable for the reaction in step a) to take place in the presence of an excess of dialkylamine. For Li[Al(NMe₂)₄] and Na[Al(NMe₂)₄], the reaction mixture can be slowly heated in order to avoid uncontrollable gas evolution. The reaction temperature should therefore be maintained at −45° C. until the gas evolution has subsided. By contrast, for the synthesis of Li[Al(NEt₂)₄] and Na[Al(NEt₂)₄], reaction temperatures up to the boiling point of the diethylamine deployed are used.

Furthermore, Li[Al(NMe₂)₄] and Na[Al(NMe₂)₄] can be easily and advantageously produced in a controlled manner by dissolving in liquid amine. The use of M[AlH₄] in the form of pressed tablets instead of powder is particularly advantageous since the tablets dissolve in boiling amine like an effervescent tablet, which means an increase in safety. An organic solvent other than the amine itself is not needed. It is to be emphasized as a particular advantage that the amine used can be recycled completely into the reaction circuit without separation problems with other solvents.

A reduction in the elemental halide or At complexing of the target amide is not observed when M[Al(NRR′)₄] is used as amide carrier (step b). The compounds M[Al(NRR′)₄] are significantly more soluble than the lithium amides used in the prior art, and they also react less exothermically with elemental halides without further solvent than lithium amides.

For the reaction of the intermediates M[Al(NRR′)₄] with elemental halides EXₓ, preferably elemental chlorides EClₓ, the following variants of the method according to the invention have proven successful in step b).

### Variant 1: (Examples 7, 8, 13)

M[Al(NRR′)₄] in organic solvent, preferably toluene or squalane, is introduced and the elemental halide is added at low temperatures of −30 to 0° C. If necessary, the reaction mixture is stirred for some time, up to 72 h, in order to complete the reaction, usually at reaction temperature initially and subsequently at room temperature, depending on the amine and elemental halide used. However, a higher reaction temperature is also conceivable. Then, the product E(NRR′), can be isolated by distillation, optionally at reduced pressure, or sublimation.

A particularly advantageous variant is the generation of Li[Al(NMe₂)₄] in HNMe₂ with recovery of the excess amine, followed by the suspension of the Li[Al(NMe₂)₄] in a high-boiling hydrocarbon, e.g. squalane, followed by reaction with EXₓ and isolation of the product E(NRR′)ₓ. In this variant, there is no need to separate solid fractions.

### Variant 2: (Examples 9, 10, 11)

This variant is particularly preferred for Lewis acids, as solid slightly less readily soluble elemental chlorides that are however significantly more soluble in the amine HNRR′ by complexing, particularly if they yield thermally sensitive elemental amides, e.g. ZrCl₄, SbCl₃, BiCl₃, TaCl₅.

After the in situ generation of M[Al(NRR′)₄] by dissolving M[AlH₄] in the amine at low temperatures of between −80 to 0° C. (optionally reflux conditions for HNMe₂), the elemental halide EXₓ is added to the amine solution of the reagent M[Al(NRR′)₄], without removing the excess amine. The amine serves as solvent, reaction mediator, adduct former and base. Alternatively, M[Al(NRR′)₄] may also be isolated first and later used with a new amine in the to reaction. The reaction mixture can still be stirred at the reaction temperature to complete the reaction. The excess amine is then removed, in the case of dimethylamine, for example, by heating the reaction mixture to room temperature. In some cases, however, it may be advantageous to remove the amine from the reaction mixture whilst still at reaction temperature or temperatures <0° C. in order to prevent a reverse reaction of the product E(NRR′)ₓ with resulting Li[AlX₄] from forming E(NRR′)_{x-z}X_{z} species. After evaporation and recovery of the excess amine, a light-boiling hydrocarbon, such as pentane or hexane, is added to the reaction mixture and the reaction product is separated off by extraction and simple decanting of the hydrocarbon solution. In special cases, the product dissolved in the amine is easily separated from the comparatively insoluble salt M[AlCl₄] by decanting and processed by distillation. Filtration is generally not necessary. The extraction agent is evaporated and recovered and the extract is subjected to fractional distillation under vacuum. Alternatively, after removal of the amine, the product E(NRR′)x may be isolated from the reaction residue by sublimation or distillation, optionally at reduced pressure.

### Variant 3

In this variant a mixture of Li[AlH₄] and Na[AlH₄] is initially reacted in the amine HNRR′ to a mixture of M[Al(NRR′)₄] (M=Li resp. Na), after conversion is complete the metal chloride MClₓ is added to said mixture at −40° C. and the mixture is heated within 5 hours to 30° C. In the case of dimethylamine, the amine largely evaporates. In the remaining melt mixture, the formed metal amide NMR can be detected spectroscopically in a good yield.

Depending on the application, it may be advantageous to also combine process steps and features from variant 1 with features from variant 2 to 3, for example if the solid metal chloride dissolves and reacts in a melt mixture of M[Al(NRR′)₄] and substances for lowering the melting point, but is thermally too sensitive as elemental amide for direct condensation out of the non-volatile salt melt.

### Variant 4

This variant is particularly preferred for volatile and thermally stable elemental amides. Example 12 illustrates this variant in more detail.

In this case, the elemental chloride is brought into direct contact with the intermediate M[Al(NRR′)₄]. A controllably exothermic reaction takes place, melting of the mixture occurs by lowering the melting point, or the mixture is melted and the exothermic reaction begins during melting. The reaction temperature is preferably adjusted below the decomposition temperature of the pure M[Al(NRR′)₄] phase. In order to improve the stirrability and reduction of the viscosity and for better heat removal, it is advantageous in some applications to add an organic diluent at 1-300 vol % to this melt mixture, preferably a high-boiling hydrocarbon, such as squalane or dodecylbenzene. The reaction temperature is in a range from 0° C. to 160° C., in particular from room temperature (20° C.) to 120° C., or at 20° C. to 160° C.

After ligand metathesis has taken place, the volatile product is condensed off from the mixture of molten salt (and optionally non-volatile hydrocarbon) under reduced pressure and optionally further purified. Filtrations or similar separation processes under nitrogen are not required in variant 4.

The invention is explained in more detail using the following examples.

### EXAMPLES

### Example 1: Preparation of Li[Al(NMe₂)₄] Starting from Recrystallized LiAlH₄

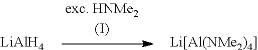

LiAlH₄ (1.00 g, 26.4 mmol, 1.0 eq) was recrystallized from ET₂O and the solvent was then removed at 100° C. and 10⁻² mbar. The colorless solid was weighed into a Schlenk flask with Teflon valve. HNMe₂ (17.3 g, 383 mmol, 14.5 eq) was condensed under cooling with liquid nitrogen. The Schlenk flask was first heated to −60° C. under vacuum in a dry ice bath. At this temperature, no reaction took place and LiAlH₄ is undissolved. The reaction mixture was further heated slowly and gas evolution was observed at a temperature of about −50° C. Moreover, LiAlH₄ dissolved slowly in the liquid HNMe₂. In the dry ice bath, the reaction mixture was kept at a temperature of −50° C. for 1 h until gas evolution slowly subsided. The reaction mixture was heated and stirred for 1 h at RT while excess HNMe₂ evaporated. After applying a vacuum (approx. 10⁻³ mbar) for approximately 2 min, a colorless solid was obtained which was dried under vacuum (approx. 10⁻³ mbar) for 1 h at 55° C. The overall yield was determined by weighing the flask at 98%. The isolated yield was 89% (4.91 g, 23.4 mmol).

¹H-NMR (THF-d₈, 300 MHz, 300 K): δ/ppm=2.49 (s, 24H, NMe₂).

¹³C-NMR (THF-d₈, 75 MHz, 300 K): δ/ppm=42.7 (NMe₂).

⁷Li-NMR (THF-d₈, 155 MHz, 300 K): δ/ppm=−0.07 (Li[Al(NMe₂)₄]).

²⁷Al-NMR (THF-d₈, 130 MHz, 300 K): δ/ppm=110.1 (Li[A/(NMe₂)₄]).

Elemental analysis: for C₈H₂₄Al₁Li₁Na.

calculated: C: 45.71%, H: 11.51%, N: 26.65%.

found: C: 43.22%, H: 10.60%, N: 25.53%.

HR-EI-MS: calculated for C₈H₂₄Al₁Li₁N₄: 210.1976 m/z, found: 210.1966 m/z.

IR: \tilde{ν}/cm⁻¹=2935 (s), 2817 (m), 2770 (m), 1447 (s), 1242 (m), 1134 (st), 1058 (m), 932 (vst), 840 (m), 624 (st), 602 (vst), 412 (vst).

### Example 2: Preparation of Li[Al(NMe₂)₄] Starting from Pestled LiAlH₄ Pellets

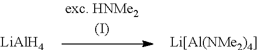

LiAlH₄ (1.51 g, 39.7 mmol, 1.00 eq; commercially available pellets, pestled inertly before use) was introduced into a Schlenk flask with Teflon valve. HNMe₂ (39.1 g, 870 mmol, 21.9 eq) was condensed under cooling with liquid nitrogen. The reaction mixture was first heated to −60° C. in a dry ice bath. At this temperature, a reaction did not yet take place. In the dry ice bath, the reaction mixture was further heated gradually, wherein slight gas evolution began from −50° C. The slightly turbid solution was stirred for 2 h at this temperature and was then heated to RT. A colorless, slightly gray solid was obtained by briefly applying a vacuum. This was dried under vacuum (approx. 10⁻³ mbar) for 30 min. The overall yield was determined as 99% (8.25 g, 39.3 mmol) by weighing the Schlenk flask. The product could be isolated with a 94% yield (7.83 g, 37.3 mmol), pestled inertly and obtained as a non-pyrophoric solid.

¹H-NMR (THF-d₈, 300 MHz, 300 K): δ/ppm=2.49 (s, 24H, NMe₂).

¹³C-NMR (THF-d₈, 75 MHz, 300 K): δ/ppm=42.7 (NMe₂).

⁷Li-NMR (THF-d₈, 155 MHz, 300 K): δ/ppm=−0.09 (Li[Al(NMe₂)₄]).

²⁷Al-NMR (THF-d₈, 130 MHz, 300 K): δ/ppm=110.1 (Li[A/(NMe₂)₄]).

Elemental analysis: for C₈H₂₄Al₁Li₁N₄.

calculated: C: 45.71%, H: 11.51%, N: 26.65%.

found: C: 44.78%, H: 11.20%, N: 26.74%.

IR: \tilde{ν}/cm⁻¹=2934 (s), 2817 (m), 2769 (m), 1447 (s), 1412 (s), 1241 (m), 1133 (st), 1057 (m), 930 (vst), 624 (st), 599 (vst).

### Example 3: Preparation of Na[Al(NMe₂)₄] Starting from NaAlH₄

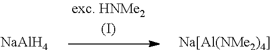

NaAlH₄ (2.24 g, 41.4 mmol, 1.00 eq; Acros, 93%) was introduced into a Schlenk flask and cooled with liquid nitrogen. HNMe₂ (29.5 g, 650 mmol, 15.8 eq) was condensed. The reaction mixture was first heated to −60° C. in a dry ice bath, with no reaction being observed. The temperature was slowly increased gradually until a gas evolution occurred at a temperature of −45° C., while NaAlH₄ slowly dissolved. The mixture was stirred for 2 h at this temperature until no more gas evolution was observed. The solution was then carefully heated to RT, wherein excess HNMe₂ evaporated. The resulting colorless solid was obtained by applying a vacuum. This was dried under vacuum (approx. 10⁻³ mbar) for 1 h at RT and then pestled inertly. The desired product was obtained with a total yield of 98% (9.18 g, 40.6 mmol) and an isolated yield of 88% (8.25 g, 36.4 mmol). The product is a slightly gray, non-pyrophoric solid.

¹H-NMR (THF-d₈, 300 MHz, 300 K): δ/ppm=2.49 (s, 24H, NMe₂).

¹³C-NMR (THF-d₈, 75 MHz, 300 K): δ/ppm=42.9 (NMe₂).

²⁷Al-NMR (THF-d₈, 130 MHz, 300 K): δ/ppm=109.9 (Na[A/(NMe₂)₄]).

Elemental analysis: for C₈H₂₄Al₁Na₁N₄.

calculated: C: 42.46%, H: 10.69%, N: 24.76%.

found: C: 39.03%, H: 9.65%, N: 23.11%.

IR: \tilde{ν}/cm⁻¹=2933 (s), 2859 (s), 2805 (m), 2757 (m), 1461 (s), 1447 (s), 1409 (s), 1244 (m), 1138 (st), 1059 (m), 936 (vst), 695 (s), 652 (s), 600 (vst) 410 (st).

### Example 4: Synthesis of Li[AlH(NEt₂)₃]

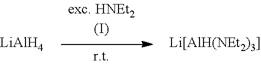

LiAlH₄ (600 mg, 15.8 mmol, 1.00 eq) was introduced and cooled to −60° C. Liquid HNEt₂ (15 mL, 146 mmol, 9.24 eq) was precooled to −30 C and slowly added. HNEt₂ (Smp=−50° C.) initially froze. The reaction mixture was warmed to −50° C., wherein HNEt₂ liquefied and LiAlH₄ slowly dissolved. At a temperature of −40° C., gas evolution could be observed, which was readily controllable. The reaction mixture was stirred for 1 h at −30° C. and then heated to RT. This produced a colorless, slightly turbid solution. Excess HNEt₂ was removed under vacuum (approx. 10⁻³ mbar), wherein a colorless solid could be isolated. This was dried for 1 h at a temperature of 60° C. The isolated yield was 89% (3.55 g, 14.1 mmol).

¹H-NMR (THF-d₈, 300 MHz, 300 K): δ/ppm=0.96 (t, ³J_{HH}=7.0 Hz, 18H, CH₂CH₃), 2.90 (³J_{HH}=7.1 Hz, 12H, CH₂CH₃).

¹³C-NMR (THF-d₈, 75 MHz, 300 K): δ/ppm=16.2 (CH₂CH₃), 42.3 (CH₂CH₃).

⁷Li-NMR (THF-d₈, 155 MHz, 300 K): δ/ppm=−0.22 (Li[AlH(NEt₂)₃]).

²⁷Al-NMR (THF-d₈, 130 MHz, 300 K): δ/ppm=117.6 (Li[AlH(NEt₂)₃]).

Elemental analysis: for C₁₂H₃₁Al₁Li₁N₃.

calculated: C: 57.35%, H: 12.43%, N: 16.72%.

found: C: 56.49%, H: 11.89%, N: 16.67%.

IR: \tilde{ν}/cm⁻¹=2958 (m), 2928 (s), 2883 (s), 2840 (s), 1647 (brs), 1445 (s), 1366 (m), 1343 (s), 1181 (m), 1148 (vst), 1105 (s), 1045 (s), 1005 (st), 896 (m), 872 (st), 789 (st), 698 (vst), 634 (m), 584 (s), 499 (m), 467 (m).

### Example 5: Preparation of Li[Al(NEt₂)₄]

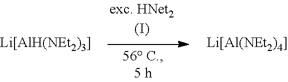

Li[AlH(NEt₂)₃] (500 mg, 1.99 mmol, 1.00 eq) was introduced and HNEt₂ (5.0 mL, 48.3 mmol, 24.3 eq) was added at RT. The reaction mixture was heated to 56° C. for 5 h, whereupon gas evolution could be observed. By means of IR spectroscopic reaction control, the completeness of the reaction was checked based on the missing Al—H band at −1650 cm⁻¹. Excess HNEt₂ was removed under vacuum (approx. 10⁻³ mbar) at RT. The colorless oily residue was then dried under vacuum (approx. 10⁻³ mbar) at 100° C., after which the crude product was dried at 3.4·10⁻⁷ mbar and 80° C. As a result, the proportion of free HNEt₂ could be reduced to 6% relative to the Li[Al(NEt₂)₄]. The product was obtained as a colorless solid with a total yield of 97% (622 mg, 1.93 mmol).

¹H-NMR (THF-d₈, 300 MHz, 300 K): δ/ppm=0.96 (t, ³J_{HH}=6.9 Hz, 24H, CH₂CH₃), 2.89 (q, ³J_{HH}=6.9 Hz, 16H, CH₂CH₃).

⁷Li-NMR (THF-d₈, 194 MHz, 300 K): δ/ppm=−0.33 (s).

²⁷Al-NMR (THF-d₈, 130 MHz, 300 K): δ/ppm=107.5 (s).

IR: \tilde{ν}/cm⁻¹=2954 (st), 2923 (m), 2860 (m), 2835 (m), 2789 (m), 2684 (w), 1451 (w), 1366 (st), 1339 (w), 1285 (w), 1260 (w), 1173 (vst), 1143 (vst), 1096 (m), 1067 (m), 1042 (m), 1011 (vst), 936 (m), 890 (st), 866 (st), 829 (m), 781 (vst), 688 (w), 644 (m), 622 (m), 573 (st), 517 (m), 470 (m), 408 (w).

### Example 6: Production of Na[Al(NEt₂)₄]

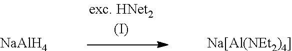

NaAlH₄ (50 mg, 0.926 mmol, 1.00 eq) was introduced, cooled to −50° C. and HNEt₂ (1.5 mL, 14.6 mmol, 15.7 eq) was slowly added. The reaction mixture was initially stirred at −50° C. for 1 h, at RT for 1 h and finally at 56° C. for 4 hours. The completeness of the reaction was checked by means of IR reaction control. The solvent was removed under vacuum (approx. 10⁻³ mbar) and the residue was digested in npentane. All volatile constituents were removed under vacuum (approx. 10⁻³ mbar) and the colorless solid dried at 5:10⁻⁵ mbar. The product was obtained with a yield of 96% (301 mg, 0.889 mmol).

¹H-NMR (THF-da, 300 MHz, 300 K): δ/ppm=0.94 (t, ³J_{HH}=6.9 Hz, 24H, CH₂CH₃), 2.90 (q, ³J_{HH}=6.9 Hz, 16H, CH₂CH₃).

¹³C-NMR (THF-da, 75 MHz, 300 K): δ/ppm=16.7 (CH₂CH₃), 42.7 (CH₂CH₃).

²⁷Al-NMR (THF-da, 130 MHz, 300 K): δ/ppm=107.8 (s).

IR: \tilde{ν}/cm⁻¹=2953 (m), 2922 (m), 2859 (m), 2792 (m), 2683 (w), 1452 (w), 1364 (m), 1339 (w), 1285 (w), 1261 (w), 1174 (st), 1097 (st), 1068 (m), 1039 (m), 1004 (vst), 928 (w), 886 (m), 870 (st), 837 (w), 789 (st), 614 (st), 470 (m), 427 (m).

Elemental analysis: for C₁₆H₄₀AlNaN₄

calculated: C: 56.77%, H: 11.91%, N: 16.55%.

found: C: 54.18%, H: 11.60%, N: 15.39%.

HR-EI-MS: calculated for C₁₆H₄₀AlN₄: 315.3068 m/z, found: 315.3057 m/z.

Melting point: 162° C. (visually 5° C./min).

### Example 7: Synthesis of P(NMe₂)₃

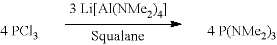

Li[Al(NMe₂)₄] (200 mg, 0.95 mmol, 0.75 eq) was suspended in 8 mL squalane and cooled to 0° C. PCl₃ (174 mg, 1.27 mmol, 1.00 eq) was added dropwise. The reaction mixture was stirred at 0° C. for 1 h, and then heated to RT and stirred for 16 h. The precipitated grayish precipitate was separated off and the product was condensed out of the filtrate under reduced pressure (10⁻² mbar) at 50° C. P(NMe₂)₃ was obtained with a yield of 73% (151 mg, 0.93 mmol).

¹H-NMR (C₆D₆, 300 MHz, 300 K): δ/ppm=2.45 (d, ³J_{HP}=9.0 Hz, NMe₂).

¹³C-NMR (C₆D₆, 75 MHz, 300 K): δ/ppm=42.9 (²J_{CP}=18.9 Hz, NMe₂).

³¹P-NMR (C₆D₆, 101 MHz, 300 K): δ/ppm=123.1.

### Example 8: Synthesis of [Ti(NMe₂)₄]

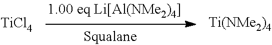

Li[Al(NMe₂)₄] (111 mg, 0.53 mmol, 1.00 eq) was added to 5 mL squalane. At 0° C., TiCl₄ (100 mg, 0.53 mmol, 1.00 eq) was added dropwise. A color change of the reaction mixture from colorless to dark yellow was immediately observed. The reaction mixture was warmed to RT and stirred for a further 16 h.

The desired product was condensed out of the reaction mixture under reduced pressure at 60° C. as a light yellow liquid with a yield of 69% (82 mg, 0.366 mmol).

¹H-NMR (C₆D₆, 300 MHz, 300 K): δ/ppm=3.11 (s, 24H, NMe₂).

¹³C-NMR (C₆D₆, 75 MHz, 300 K): δ/ppm=43.9 (NMe₂).

### Example 9: Synthesis of [Zr(NMe₂)₄]

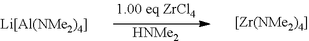

Li[Al(NMe₂)₄ (204 mg, 0.970 mmol, 1.00 eq) was added to liquid HNMe₂ and slowly heated to −40° C. ZrCl₄ (226 mg, 0.970 mmol, 1.00 eq) was added in portions, whereupon a color change from colorless to slightly yellow was observed. The reaction mixture was stirred for 1 h at −40° C. and then freed of excess amine under vacuum (approx. 10⁻³ mbar) at −40° C. The slightly yellow residue was heated to RT and the product was sublimated out of the residue under vacuum (approx. 10⁻³ mbar) at 45° C. [Zr(NMe₂)₄] was obtained with a yield of 81% (210 mg, 0.786 mmol) in the form of colorless crystals.

The reaction may also be carried out starting from LiAlH₄ and NaAlH₄, which is reacted in HNMe₂ in situ, or starting from previously isolated Na[Al(NMe₂)_{4].}

¹H-NMR (C₆D₆, 300 MHz, 300 K): δ/ppm=2.97 (s).

¹³C-NMR (C₆D₆, 75 MHz, 300 K): δ/ppm=41.6 (s).

HR-EI-MS: calculated for C₈H₂₄N₄Zr: 266.1048 m/z, found: 266.1050 m/z.

### Example 10: Synthesis of [Ta(NMe₂)₅]

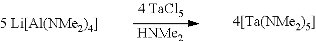

Li[Al(NMe₂)₄ (222 mg, 1.06 mmol, 5.00 eq) was added to liquid HNMe₂ and slowly heated to −40° C. TaCl₅ (303 mg, 0.845 mmol, 4.00 eq) was added in portions, wherein a color change from colorless to orange was observed.

The reaction mixture was stirred for 1 h at −40° C. and then freed of excess amine under vacuum (approx. 10⁻³ mbar) at −40° C. The residue was brought to RT and the product was sublimated out under vacuum (approx. 10⁻³ mbar) at 40° C. [Ta(NMe₂)₅] was obtained in the form of orange crystals with a yield of 77% (261 mg, 0.651 mmol).

The reaction may also be carried out starting from LiAlH₄ and NaAlH₄, which is reacted in HNMe₂ in situ, or starting from Na[Al(NMe₂)_{4].}

¹H-NMR (C₆D₆, 300 MHz, 300 K): δ/ppm=3.26 (s).

¹³C-NMR (C₆D₆, 75 MHz, 300 K): δ/ppm=43.1 (s).

HR-EI-MS: Calculated for C₈H₂₄N₄Ta: 357.1481 m/z, found: 357.1497 m/z.

### Example 11: Synthesis of [Al(NEt₂)₃]

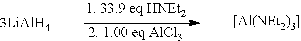

LiAlH₄ (50 mg, 1.32 mmol, 3.00 eq) was introduced and HNEt₂ (1.09 g, 14.9 mmol, 33.9 eq) was added. The suspension-like reaction mixture was heated to boiling point for 2 h, cooled to 0° C. and AlCl₃ (59 mg, 0.440 mmol, 1.00 eq) was added. The reaction mixture was stirred for 1 h at 0° C. and for 16 h at RT before 10 mL nhexane was added. The suspension was filtered and the colorless filtrate was evaporated to dryness to yield the product as a colorless oil. The yield was 90% (386 mg, 1.58 mmol).

¹H-NMR (C₆D₆, 300 MHz, 300 K): δ/ppm=1.24 (t, ³J_{HH}=6.7 Hz, 18H,

CH₂CH₃), 3.12 (q, ³J_{HH}=6.7 Hz, 12H, CH₂CH₃).

¹³C-NMR (C₆D₆, 75 MHz, 300 K): δ/ppm=12.7 (CH₂CH₃), 39.9 (CH₂CH₃).

²⁷Al-NMR (C₆D₆, 130 MHz, 300 K): δ/ppm=117.8 (s).

### Example 12: Synthesis of [Al(NEt₂)₃]

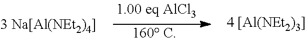

Na[Al(NEt₂)₄] (337 mg, 1.00 mmol, 3.00 eq) and AlCl₃ (44 mg, 0.33 mmol, 1.00 eq) were introduced together and melted without the addition of solvent. On account of the reaction and accompanying lowering of the melting point, a colorless melt, in which some insoluble NaCl was suspended, formed from 130° C. onwards. After 1 h at 160° C., the volatile product [Al(NEt₂)₃] was condensed out of the melt under vacuum (10⁻³ mbar). The yield was >90%. ¹H-NMR (C₆D₆, 300 MHz, 300 K): δ/ppm=1.24 (t, ³J_{HH}=6.7 Hz, 18H, CH₂CH₃), 3.12 (q, ³J_{HH}=6.7 Hz, 12H, CH₂CH₃).

### Examples 13

The following syntheses of Si(NMe₂)₄ (Example 13a) and E(NMe₂)₃ (where E=As (Example 13b), Sb (Example 13c), Bi (Example 13d)) were carried out in an NMR tube starting from one mmol Li[Al(NMe₂)₄] without isolation of the products:

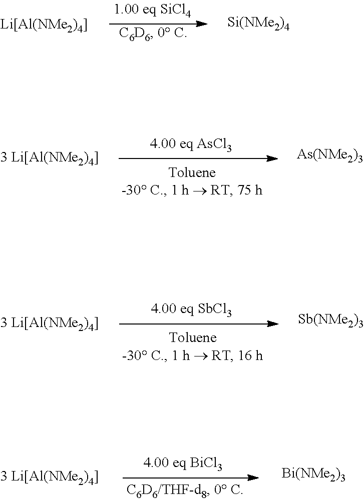

The chemical shift of each of the products present in solution was compared to literature data and reference samples, thereby identifying the products. The isolation of Si(NMe₂)₄ and As(NMe₂)₃ from toluene was unsuccessful due to the high volatility, as well as the small batch sizes. Sb(NMe₂)₃ and Bi(NMe₂)₃ could also be detected, but both compounds are very unstable, especially photosensitive substances, which is why isolation did not take place in this case either. Generally, the dimethylamido-substituted species of the main group elements show no tendency to undergo a reverse reaction to form mixed-substituted compounds. The reactions were not optimized but, with careful reaction control and exact stoichiometry similar to that of P(NMe₂)₃, they proceed very selectively and almost quantitatively. Yield losses are expected, particularly in the isolation of the products detected.

Si(NMe₂)₄: ¹H-NMR (C₆D₆, 300 MHz, 300 K): δ/ppm=3.26 (s).^{[1]}

As(NMe₂)₃: ¹H-NMR (C₆D₆, 300 MHz, 300 K): δ/ppm=2.61 (s).^{[2]}

Sb(NMe₂)₃: ¹H-NMR (C₆D₆, 300 MHz, 300 K): δ/ppm=2.76 (s).^{[2]}

Bi(NMe₂)₃: ¹H-NMR (C₆D₆/THF-d₈, 300 MHz, 300 K): δ/ppm=3.14 (s).^{[3]}[1] Banerjee et al., Inorg. Chem. Commun. 2006, 9, 761-763. [2] Schumann, J. Organomet. Chem. 1986, 299, 169-178. [3] Ando et al., J. Inorg. Nucl. Chem. 1975, 37, 2011.

1. Method for producing compounds of type E(NRR′)ₓ comprising the following steps:
a) reacting M[AlH₄] with HNRR′ to form M[Al(NRR′)₄] and hydrogen;
b) reacting M[Al(NRR′)₄] with EXₓ to form E(NRR′)ₓ and M[AlX_{4]},
wherein M=Li, Na or K, R=CₙH₂ₙ₊₁, where n=1 to 20, and independently thereof R′=CₙH₂ₙ₊₁, where n=1 to 20, E is an element of the groups 3 to 15 of the periodic table of the elements, preferably Zr, Ta, Nb, Bi, As, P, B, Si or Ge, X=F, Cl, Br or I and x=2, 3, 4 or 5.

2. Method according to claim 1, characterized in that R==CH₃ or C₂H₅.

3. Method according to claim 1 or 2, characterized in that M=Li or Na.

4. Method according to claim 1, characterized in that X=Cl.

5. Method according to claim 1, characterized in that step b) is carried out in an organic solvent.

6. Method according to claim 1, characterized in that step b) is carried out in an amine as solvent.

7. Method according to claim 1, wherein step b) is carried out in a temperature range of from −80° C. to 160° C., in particular from −40° C. to 120° C. or from 0° C. to 120° C.

8. Method according to claim 1, characterized in that in step b) a stoichiometric amount of M[Al(NRR′)₄] is used and a heteroleptic compounds E(NRR′)ₓX_{y}, in which the halide ligands are replaced only partially by amide ligands, is obtained.

9. Method according to claim 18, characterized in that, in step b), after the reaction has taken place, the amine is removed at temperatures of between −80° C. and 0° C.

10. Method according to claim 1, characterized in that, in step b) after the reaction has taken place, it is isolated by sublimation.

11. Method according to claim 1, characterized in that, after step a) and before step b), excess amine HNRR′ is removed.

12. Method according to claim 1, characterized in that step a) is carried out in the presence of an excess of amine HNRR′.
